(19) United States
(12) Patent Application Publication
(10) Pub. No.: US 2013/0318578 A1
(43) Pub. Date: Nov. 28, 2013

(54) PASSWORD MANAGEMENT AND SMART HONEY POT SYSTEM

(71) Applicant: Siva Sai Prasad Palagummi, Hyderabad (IN)

(72) Inventor: Siva Sai Prasad Palagummi, Hyderabad (IN)

(73) Assignee: CA, Inc., Islandia, NY (US)

(21) Appl. No.: 13/479,495

(22) Filed: May 24, 2012

(51) Int. Cl. G06F 21/00

(52) U.S. Cl. 726/6

(57) ABSTRACT

A system creates a weak password using a regular expression, and stores the weak password. The system receives a password from a user or a third party, and executes a first action when the password from the user or the third party is the weak password. In another embodiment, the system stores a strong password as a weak password and creates a new strong password. The system receives a password from a user or a third party, and executes a first action when the password is the new strong password and executes a second action when the password is the weak password.

### BACKGROUND

The present disclosure relates to a password management and smart honey pot system, and more specifically, in a particular embodiment, to a password management and smart honey pot system that uses a regular expression and auto-configuration of strong and weak passwords.

### BRIEF SUMMARY

According to one aspect of the present disclosure, a computer processor and a computer storage device are configured to create a weak password using a regular expression. In another embodiment, the weak password is stored in the computer storage device. Thereafter, a password is received from a user or a third party, and a first action is executed when the password from the user or the third party is the weak password.

According to another aspect of the present disclosure, a computer processor and a computer storage device are configured to create a strong password, store the strong password in the computer storage device, store the strong password in the computer storage device as a weak password, and create a new strong password. In another embodiment, the computer processor is further configured to store the new strong password in the computer storage device, receive a password from a user or a third party, execute a first action when the password from the user or the third party is the new strong password, and execute a second action when the password from the user or the third party is the weak password.

### BRIEF DESCRIPTION OF THE DRAWINGS

Aspects of the present disclosure are illustrated by way of example and are not limited by the accompanying figures with like references indicating like elements.

FIGS. 1A and 1B illustrate a flowchart of a process to create a weak password from a regular expression.

FIG. 2 illustrates a flowchart of a process to store a strong password as a weak password upon the creation of a new strong password.

FIG. 3 illustrates a block diagram of a computer system upon which one or more embodiments can execute.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

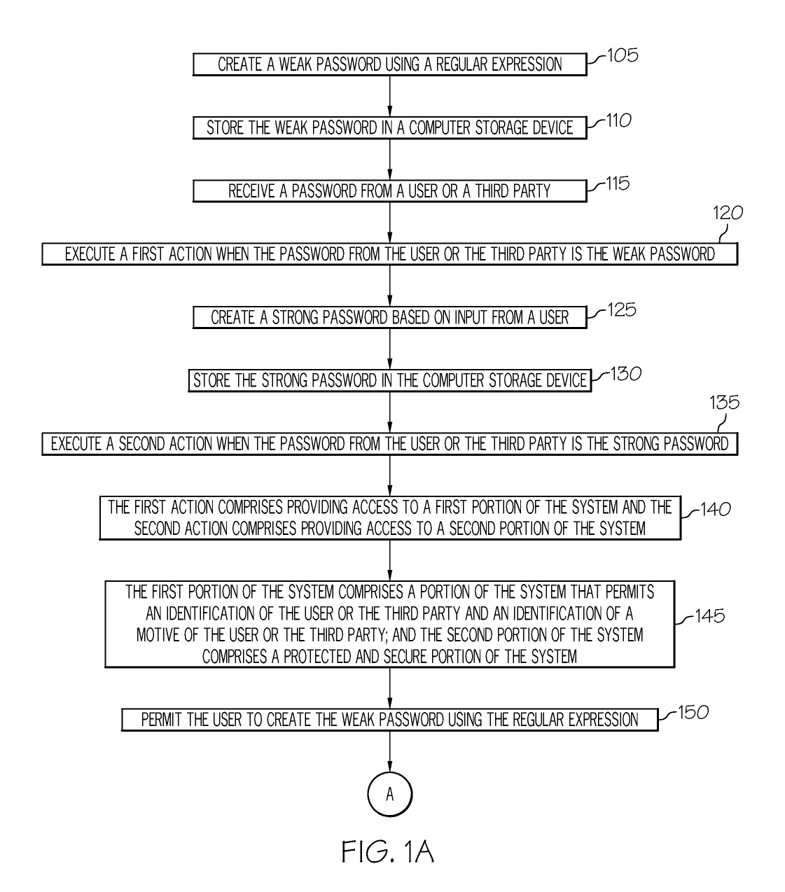

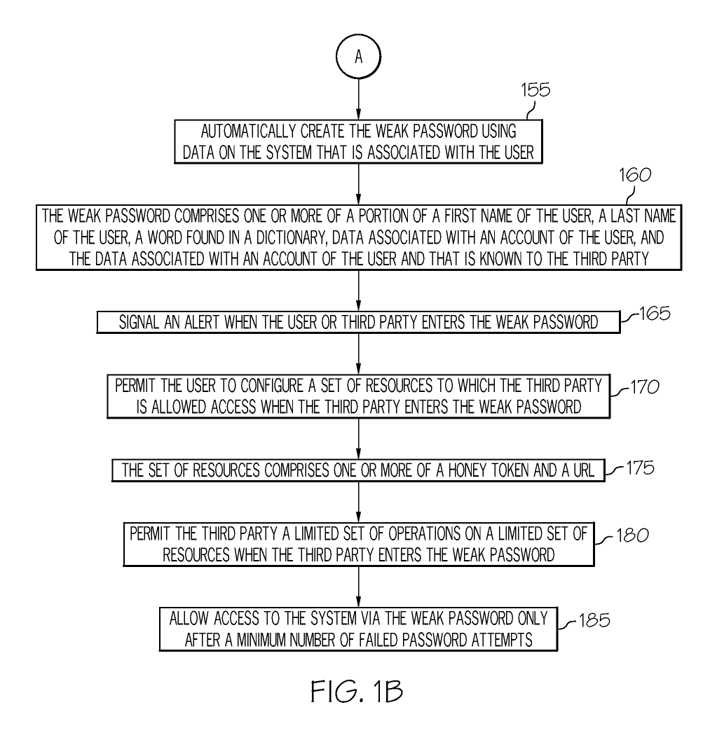

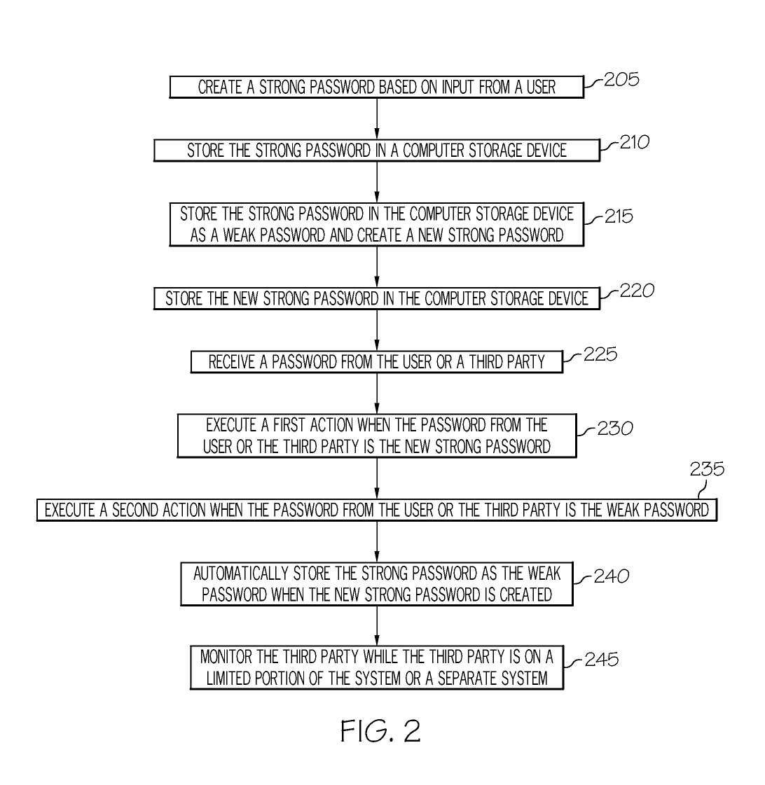

FIGS. 1A, 1B, and 2 are flowcharts of example processes 100 and 200 for a process to create a weak password from a regular expression and a process to store a strong password as a weak password upon the creation of a new strong password. FIGS. 1A, 1B, and 2 include a number of process blocks 105-185 and 205-245 respectively. Though arranged serially in the examples of FIGS. 1A, 1B, and 2, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

In computing, a regular expression provides a concise and flexible means to “match” (specify and recognize) strings of text, such as particular characters, words, or patterns of characters. A regular expression can be written in a formal language that can be interpreted by a regular expression processor, which is a program that either serves as a parser generator or examines text and identifies parts that match the provided specification. Examples of regular expressions include the sequence of characters “car” appearing consecutively, such as in “car”, “cartoon”, or “bicarbonate”; the word “car” when it appears as an isolated word; and the word “car” when preceded by the word “motor”. Regular expressions are used by text editors, utilities, and programming languages to search and manipulate text based on patterns. Wildcards differ from regular expressions in generally expressing only limited forms of patterns.

Referring now to FIGS. 1A and 1B, a system includes a computer processor and a computer storage device configured, at 105, to create a weak password using a regular expression. A weak password is one that can be easily compromised by an unauthorized person. At 110, the weak password is stored in the computer storage device. At 115, a password is received from a user or a third party, and at 120, a first action is executed when the password from the user or the third party is the weak password. The system allows an administrator to use the weak password regular expression to create traps and catch hackers and intruders.

At 125, the computer processor is configured to create a strong password based on input from the user. A strong password is a password that cannot be easily compromised by an unauthorized person. The strong password can be maintained within the system or on an external or third party system. At 130, the strong password is stored in the computer storage device, and at 135, a second action is executed when the password entered by the user or the third party is the strong password. As illustrated at 140, the first action includes providing access to a first portion of the system and the second action includes providing access to a second portion of the system. As further illustrated at 145, the first portion of the system includes a portion of the system that permits an identification of the user or the third party and an identification of a motive of the user or the third party. The second portion of the system includes a protected and secure portion of the system.

At 150, a user is permitted to create the weak password using the regular expression (as contrasted with the system automatically creating the weak password). At 155, the weak password is automatically created using data on the system that is associated with the user. At 160, the weak password includes one or more of a portion of a first name of the user, a last name of the user, a word found in a dictionary, data associated with an account of the user, and the data associated with an account of the user and that is known to the third party. At 165, an alert is signaled when the user or third party enters the weak password.

At 170, a user is permitted to configure a set of resources to which the third party is allowed access when the third party enters the weak password. At 175, the set of resources that a user is allowed to configure can include a honey token and a URL. At 180, a third party is permitted to execute a limited set of operations on a limited set of resources when the third party enters the weak password. At 185, access is allowed to the system via the weak password only after a minimum number of failed password attempts.

Referring now to FIG. 2, a system includes a computer processor and a computer storage device that are configured, at 205, to create a strong password based on input from a user, and at 210, store the strong password in the computer storage device. Sometime thereafter, whether it is days, weeks, months, or longer, at 215, the strong password is stored in the computer storage device as a weak password, at 220, a new strong password is created based on input from the user, and at 225, the new strong password is stored in the computer storage device. At 230, the system receives a password from a user or a third party. At 235, the system executes a first action when the password from the user or the third party is the new strong password, and at 240, the system executes a second action when the password from the user or the third party is the weak password.

At 245, the system automatically stores the strong password as the weak password when the new strong password is created, and at 250, the system monitors the third party while the third party is on a limited portion of the system or a separate system.

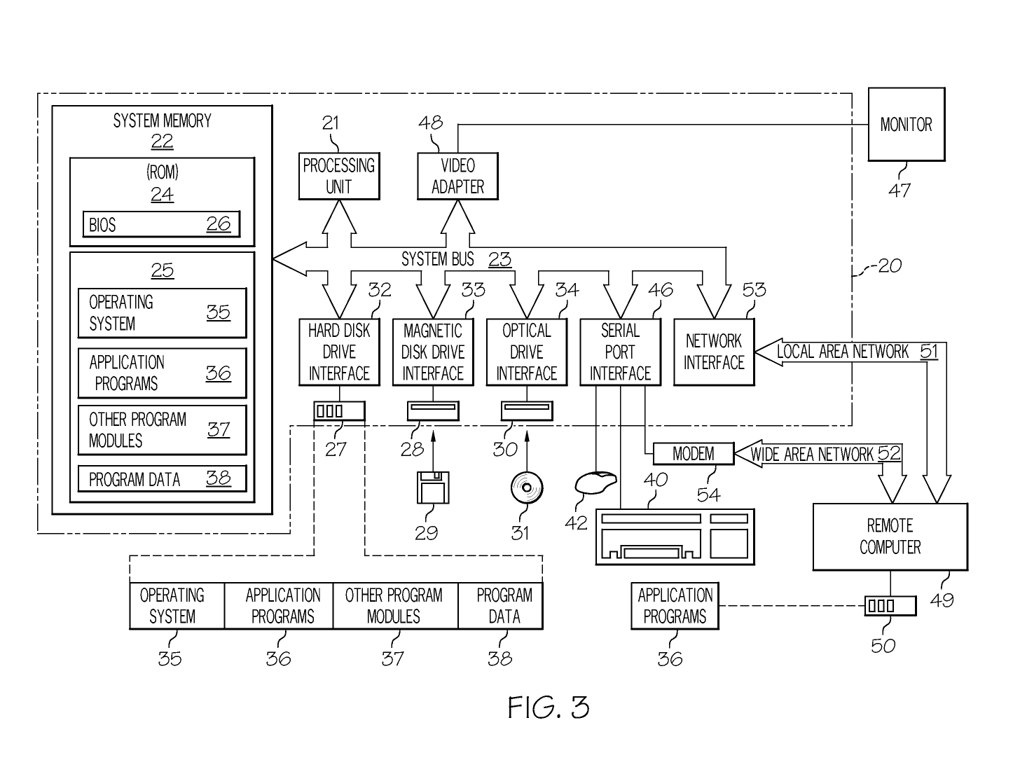

FIG. 3 is an overview diagram of hardware and an operating environment in conjunction with which embodiments of the invention may be practiced. The description of FIG. 3 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 3, a hardware and operating environment is provided that is applicable to any of the servers and/or remote clients shown in the other Figures.

As shown in FIG. 3, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 3 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A system comprising:
a computer processor and a computer storage device configured to:
create a weak password using a regular expression;
store the weak password in the computer storage device;
receive a password from a user or a third party; and
execute a first action when the password from the user or the third party is the weak password.

2. The system of claim 1, wherein the computer processor and the computer storage device is configured to:
create a strong password based on input from the user;
store the strong password in the computer storage device; and
execute a second action when the password from the user or the third party is the strong password.

3. The system of claim 2, wherein the first action comprises providing access to a first portion of the system and the second action comprises providing access to a second portion of the system.

4. The system of claim 2, wherein the first portion of the system comprises a portion of the system that permits an identification of the user or the third party and an identification of a motive of the user or the third party; and wherein the second portion of the system comprises a protected and secure portion of the system.

5. The system of claim 1, wherein the computer processor is configured to permit the user to create the weak password using the regular expression.

6. The system of claim 1, wherein the computer processor is configured to automatically create the weak password using data on the system that is associated with the user.

7. The system of claim 1, wherein the weak password comprises a portion of a first name of the user, a last name of the user, a word found in a dictionary, data associated with an account of the user, or the data associated with an account of the user and that is known to the third party.

8. The system of claim 1, wherein the computer processor is configured to signal an alert when the user or third party enters the weak password.

9. The system of claim 1, wherein the computer processor is configured to permit the user to configure a set of resources to which the third party is allowed access when the third party enters the weak password.

10. The system of claim 8, wherein the set of resources comprises a honey token or a URL.

11. The system of claim 1, wherein the computer processor is configured to permit the third party a limited set of operations on a limited set of resources when the third party enters the weak password.

12. The system of claim 1, wherein the computer processor is configured to allow access to the system via the weak password only after a minimum number of failed password attempts.

13. A computer program product comprising:
a computer readable storage medium having computer readable program code embodied therewith, the computer readable program code comprising:
computer readable code configured to create a user weak password using a regular expression;
computer readable code configured to store the weak password in the computer storage device;
computer readable code configured to receive a password from a user or a third party; and
computer readable code configured to execute a first action when the password from the user or the third party is the weak password.

14. The computer program product of claim 13, comprising:
computer readable code configured to create a strong password based on input from the user;
computer readable code configured to store the strong password in the computer storage device; and
computer readable code configured to execute a second action when the password from the user or the third party is the strong password.

15. The computer program product of claim 14, wherein the first action comprises providing access to a first portion of the system and the second action comprises providing access to a second portion of the system.

16. The computer program product of claim 15, wherein the first portion of the system comprises a portion of the system that permits an identification of the user or the third party and an identification of a motive of the user or the third party; and wherein the first portion of the system comprises a protected and secure portion of the system.

17. A system comprising:
a computer processor and a computer storage device configured to:
create a strong password based on input from a user;
store the strong password in the computer storage device;
store the strong password in the computer storage device as a weak password and create a new strong password;
store the new strong password in the computer storage device;
receive a password from the user or a third party;
execute a first action when the password from the user or the third party is the new strong password; and
execute a second action when the password from the user or the third party is the weak password.

18. The system of claim 17, wherein the computer processor is configured to automatically store the strong password as the weak password when the new strong password is created.

19. The system of claim 17, wherein the computer processor is configured to monitor the third party while the third party is on a limited portion of the system or a separate system.

20. A system comprising:
a computer processor and a computer storage device configured to create a weak password using a regular expression.

21. A method comprising:
creating a weak password using a regular expression;
storing the weak password in the computer storage device;
receiving a password from a user or a third party; and
executing a first action when the password from the user or the third party is the weak password.

22. The method of claim 21, comprising:
creating a strong password;
storing the strong password in the computer storage device; and
executing a second action when the password from the user or the third party is the strong password.

23. A method comprising:
creating a strong password;
storing the strong password in the computer storage device;
storing the strong password in the computer storage device as a weak password and create a new strong password;
storing the new strong password in the computer storage device;
receiving a password from a user or a third party;
executing a first action when the password from the user or the third party is the new strong password; and
executing a second action when the password from the user or the third party is the weak password.

24. The method of claim 23, comprising automatically storing the strong password as the weak password when the new strong password is created.

25. The method of claim 23, comprising monitoring the third party while the third party is on a limited portion of the system or a separate system.
